(19) United States
(12) Patent Application Publication
(10) Pub. No.: US 2005/0287376 A1
(43) Pub. Date: Dec. 29, 2005

(54) Corrosion protection of zinc surfaces

(76) Inventor: Thomas H. Rochester, Jackson, MI (US)

Correspondence Address: Thomas H. Rochester;c/o Plating Systems, 317 North Mechanic Street, Jackson, MI, 49201, US

(21) Appl. No.: 11/159,881

(22) Filed: Jun. 23, 2005

Related U.S. Application Data
(60) Provisional application No. 60/583,047, filed on Jun. 25, 2004.

(51) Int. Cl. B32B 15/04; B05D 1/38; B05D 3/02; C08L 83/00

(52) U.S. Cl. 428/450; 106/287.14; 427/402; 528/25; 427/387

(57) ABSTRACT

I have discovered that a mixture of a partially hydrolyzed zinc silicate and a waxy lubricant may be applied to a zinc surface to greatly enhance the corrosion protection. The admixture of an alkyl alkoxy silane or tetraalkoxy silane improves the corrosion protection offered by this mixture.

### CROSS-REFERENCE TO RELATED APPLICATIONS

This application claims the benefit of provisional patent application Ser. No. 60/583,047 filed Jun. 25, 2004 by the present inventor.

### FEDERALLY SPONSORED RESEARCH Not Applicable SEQUENCE LISTING OR PROGRAM

Not Applicable

### BACKGROUND OF THE INVENTION—FIELD OF THE INVENTION

Zinc is often applied to steel parts, e.g., by hot-dip galvanizing (dipping in molten zinc), electroplating, mechanical plating, as well as other methods. Zinc applies sacrificial protection to the steel parts. Zinc is a very active metal. Zinc begins to corrode quickly when exposed to the environment. Thus there have been a number of treatments developed to improve the corrosion protection of zinc. Most of these treatments function by delaying the attack of the environment on the zinc surface.

One method of delaying the onset of this corrosion is the application of a chromate conversion coating. Such a coating converts the zinc surface to zinc chromate. Zinc chromate is a highly effective corrosion inhibitor. Such products have successfully protected zinc surfaces used in commerce for over 60 years.

The End of Life Vehicle Directive (ELVD) is the name given to the European Union to a directive addressing waste generated by vehicles through the reuse, recycling and recovery of end-of-life vehicles and their components. After Jul. 1, 2003, European Union member countries were to ensure that materials used do not contain hexavalent chromium subject to a maximum level of hexavalent chromium at 2 grams per vehicle. However, prior to that standard becoming effective, on Jun. 27, 2002 the European Union extended the date to Jul. 1, 2007. At the same time it reduced the hexavalent chromium level to (essentially) zero. This specification technically affects only vehicles in Europe. However, because of worldwide sourcing issues, the End of Life Vehicle Directive is essentially a worldwide mandate. These mandates are, of course, subject to revision and reevaluation. They may be modified by the European Union at any time.

Thus there is a very real need for a hexavalent-chromium free deposit that will perform at least as well as traditional hexavalent chromate systems. Ipso facto, there is a genuine need for a chrome-free topical surface treatment for zinc.

It has been known to protect zinc surfaces such as galvanized steel by using silicate treatments, e.g., a coating of sodium or potassium water glass, to provide corrosion resistance for the zinc surface.

Such coatings ostensibly compare favorably with zinc substrates that are chromate treated.

It is well known to make a zinc coating from zinc dust and what is called “Ethyl Silicate 40”, a partially condensed ethyl silicate. Such a product is nominally 40% solids and is a short condensate polymer of ethyl silicate with about 5 silicon atoms, e.g. (C₂H₅O(SiOC₂H₅)₅OC₂H₅).

Hydrolyzed alkyl silicates are used extensively in zinc-rich primers. It is generally accepted that these zinc-rich primers outperform those primers in which epoxy-polyamide binder systems are used to bond the zinc dust to itself and to the surface of the protected substrate. This view is set forth in “Zinc Silicate or Zinc Epoxy as the Preferred High Performance Primer” by Mike J. Mitchell, International Protective Coatings (Akzo Nobel). It is my belief that the reason that these ‘zinc silicates’ outperform zinc-rich epoxy formulations, at least in part, is because the binder—the silicate—contributes corrosion inhibition to the coating.

### BACKGROUND OF THE INVENTION—PRIOR ART

Neish (U.S. Pat. No. 2,665,232) describes a process in which zinc surfaces are treated with a mixture of silicate and an alkali metal salt of chromic acid and then dried to produce a coating that retards the formation of white corrosion products. (e.g., zinc oxide, zinc carbonate, etc.).

The key patent involving alkyl silicates in corrosion protection is that of Lopata and Keithler (U.S. Pat. No. 3,056,684), who invented a protective coating comprised of a partially hydrolyzed tetraethyl orthosilicate and zinc dust. Since that invention, there have been numerous modifications of this core technology.

In the context of considering the Lopata invention and its' successors it is obvious that the simple topical application of an alkyl silicate or condensation product thereof to a zinc-containing surface is not a new art.

Law (U.S. Pat. No. 3,653,970) describes a one package zinc rich coating containing zinc dust, an organic polysilicate and an amine.

McLeod in U.S. Pat. No. 3,730,743 describes a coating composition containing particulate zinc and a vehicle consisting of an alkyl polysilicate and an organic solvent.

Boaz (U.S. Pat. No. 3,730,746) describes a vehicle composed of partially hydrolyzed ethyl silicate, a vinyl resin and other components.

McLeod in U.S. Pat. No. 3,917,648 describes a galvanically protective coating comprising zinc dust and polyol silicates.

Schutt (U.S. Pat. No. 4,071,380) describes of method of treating a corrodible steel substrate with an alkyl silicate and permitting the coating to cure by hydrolysis.

Ginsberg (U.S. Pat. No. 4,084,971) describes a ferrous metal protecting composition of zinc, a partially hydrolyzed organic silicate and a fatty acid amidoamine.

Ginsberg (U.S. Pat. No. 4,239,539) described a single-package zinc-rich coating composition are produced by blending zinc, a partially hydrolyzed organic silicate and an aminoorganosilicon acylamino compound.

Brown (U.S. Pat. No. 4,290,811) describes an improved method of preparing hydrolyzed silicate binders wherein the hydrolysis is catalyzed in the presence of a strong acid form ion exchange resin.

Isarai, et. al. (U.S. Pat. No. 4,305,979 patented a process for curing a coated film of an alkyl silicate type zinc rich paint, which comprises coating a substrate with an alkyl silicate type zinc rich paint, and then treating the resulting coated film with an aqueous liquid containing a basic substance, thereby to promote the curing of the coated film.

It is also known to apply silicate treatments to coatings formed from dibasic acids, hexavalent chromium compounds and metallic flaked powders, with such silicate coatings providing extended corrosion protection (U.S. Pat. No. 4,365,003 to Danforth and deRidder).

Frey, et. al. (U.S. Pat. No. 4,555,445) described a coating composite composed of, inter alia, a topcoat with a copolymer component and a silicate substance.

Montes (U.S. Pat. No. 4,647,479) describes a corrosion-inhibiting composition comprising an organic silicate, citric acid, and a non-aqueous solvent applied directly over steel.

Sutherland (U.S. Pat. No. 4,657,599) describes a process in which zinc plated parts are treated with, first, a hexavalent chromium-containing solution to produce a yellow to olive drab color, then treated with an alkali metal silicate, preferably at an elevated temperature. This significantly enhances the corrosion protection supplied by the coating system. For example, zinc plated parts might achieve about one hundred hours in salt spray; the production of a chromate conversion coating on the surface would increase this to about two hundred hours; but the subsequent treatment with an alkali metal silicate would improve the performance of the system to 500 to 600 hours.

Nagani (U.S. Pat. No. 5,091,009) disclosed a coating composition for forming an inorganic film by hydrolyzing and condensing a metal alkoxide in the presence of an aluminum salt; and adding a deposition inhibitor which prevents the separation of the aluminum salt when a film is formed.

Savin (U.S. Pat. No. 5,677,367) describes, inter alia, a composition comprising graphite (a conductive lubricant) and a silicate, which can be an alkali metal silicate or an alkyl silicate.

Shimuzu (U.S. Pat. No. 6,235,348) describes a rust preventive composition of a silicic acid compound and an aromatic amine-based condensation product applied over zinc.

Cole, et. al. (U.S. Pat. No. 5,068,134) describe a process of protecting galvanized metal from white rust corrosion which comprises treating the zinc coating with a silica compound at an elevated temperature.

Montes (U.S. Pat. No. 4,647,479) teaches a steel primer comprising an organic silicate prehydrolyzed in an amount of 70% to 90%.

Savin (U.S. Pat. No. 5,338,348) describes a coating composition for use in protecting metallic substrates from corrosion, consisting of a film-forming substance, zinc powder, zinc flakes, amorphous silica, and particulate ferrophosphate.

### OBJECTS OF THE INVENTION

The primary object of my invention is to provide a coating that may be applied to zinc that significantly improves the corrosion protection, particularly in the ASTM B-117 Salt Spray Test.

A further object of this invention is to provide a surface that is lubricious. This is particularly advantageous when my inventive solution is applied to threaded fasteners such as nuts, bolts, and machine screws. The lubricity provided by my inventive solution, when cured, contributes a consistent relationship between the torque applied to the threaded assembly and the tension on the member so tensioned.

Another object of my invention is to achieve the aforementioned objects without the use of hexavalent chromium.

Yet a further object of my invention is to provide a coating that achieves full functionality without the use of heat in the curing cycle.

Yet another object of the invention is to provide a water-repellent surface that by repelling water improves the corrosion protection.

Yet another object of my invention is to provide a surface treatment for zinc that does not introduce any objectionable materials into the waste stream.

### SUMMARY OF THE INVENTION

My invention is quite simple. A zinc plated or coated steel object is dipped into to solution containing a partially hydrolyzed alkyl silicate and a waxy compound. The excess is removed and the part is allowed to dry and to cure by reacting with atmospheric water. In the ASTM B-117 Salt Spray Test, the resultant deposit gives better corrosion protection for thin coatings than any sacrificial coatings heretofore known.

The organic silicates that can be, or have been, useful include derivatives of the alkyl silicates, e.g., ethyl, propyl, butyl and polyethyl silicates, as well as alkoxyl silicates such as ethylene glycol mono ethyl silicate, tetra isobutyl silicate and tetra isopropyl silicate, and further including aryl silicates such as phenyl silicates. Most generally for economy, the organic silicate is derived from tetetraethyl orthosilicate or TEOS, (C₂H₅O)₄Si.

The waxy compound may be either soluble in the alcoholic ethyl polysilicate solution or dispersible in it. While an abundance of choices face the formulator the most obvious choices are micronized waxes (polyethylene, polypropylene, perfluorinated waxes and others) and soluble waxy compounds such as higher (e.g., C₈ and up) such as alcohols.

I have found that a particularly useful waxy compound that may be used in my invention is a Werner complex of trivalent chromium and a fatty acid with a carbon chain of approximately 13 to 17 carbon atoms. An especially effective compound is di-pentahydroxy (tetradecanoato) Chromium, available commercially from Zaclon (Cleveland, Ohio) as Quilon C. Other Werner complexes with a fatty acid content may also be effective in my invention. Specifically, I have found that other products sold under the trade name Quilon work approximately as well as Quilon C.

Without wishing to be bound by any specific explanation, I would like to summarize why this invention is so extraordinarily effective in improving the salt spray protection of zinc surfaces. The silicon-oxygen bond has long been viewed as an effective inhibitor; indeed, silicates are seen as quite highly effective inhibitors (although not as effective as hexavalent chromium-containing formulations). Upon hydrolysis, the ethyl silicate and ethyl polysilicate form many silicon-oxygen bonds. However, this hydrolysis product is quite friable and easily subject to mechanical damage. The incorporation of a wax, and particularly a Werner complex wax, improves the film-forming capability of the coating and thereby enhances the physical integrity of the film.

Most generally for economy, the organic silicate is derived from tetraethyl silicate (tetraethyl orthosilicate, TEOS, (C₂H₅O)₄Si.

The partial hydrolysis of tetraalkyl silicate proceeds as follows:
(RO)₄Si+H₂O→(RO)₃SiOH+ROH⇑

Further hydrolysis proceeds as follows:
(RO)₃—Si—OH+H₂O→RO—Si(OR)₂—O—Si(OR)₂—OR+H₂O

Continued reaction with water increases the chain length with reactions also continuing between independent polymer chains. Complete hydrolysis yields (eventually) a chemically and thermally stable silicon-oxygen matrix.

In general, the alkoxy moiety is ethoxy; however, methoxy moieties are also effective. Larger alkoxy moieties may be used, such as propoxy moieties. In general, the more carbon atoms in the compound, the slower will be the rate of cure.

This prehydrolyzed alkyl silicate is then applied to a zinc surface in my invention with the other components and further hydrolysis results in the elimination of the alkoxy moieties with the formation of Zn—O—Si and Si—O—Si bonds.

I have found that a very thin coating of this novel mixture is sufficient to greatly enhance the salt spray protection of the zinc substrate. The coverage of the solution is 43,000 square feet per gallon. Thus the coating formed is typically on the order of 0.003 to 0.004 grams per square meter.

The ASTM-B-117 Salt Spray Test

The purpose of an accelerated corrosion test, such as the salt spray test, is to duplicate, in the laboratory, insofar as possible, the corrosion performance of a product in the field. This allows scientists and engineers the opportunity to advance the development of new products in a quick manner. The salt spray test has been used extensively for this purpose. With respect to coated steel sheet products, it has been used for many years by researchers involved with the development of new metallic coatings, new paint coatings, as well as miscellaneous types of chemical treatments and paint pretreatments applied to metallic-coated steel sheet products.

One requirement for an accelerated corrosion test to be useful is that the results correlate with the performance in the real world. Unfortunately for the salt spray test, no one has ever been able to demonstrate that it correlates with any type of atmospheric exposure. This leads many researchers to conclude that the salt spray test has no relevance, and should be discontinued. However, there continues to be extensive use of this test in product literature, in customer specifications, in product data sheets, as well as in the technical literature. The results quoted in this literature give the “life” of a given type of coating, the benefits of “new” paint systems, the salt spray requirements for the acceptance by an end customer of an alternative product, etc., so it seems virtually impossible to stop using the salt spray test at this time. In fact, there are so many specifications in use today that require a product to exhibit a specified number of “hours to failure” in the salt spray test, that any change to the test or its' elimination seems impossible. Clearly, any push to eliminate it would require that alternate accelerated corrosion tests be proposed and accepted by architects, specification writers, etc. Simply put, the performance of different products with respect to corrosion behavior have been compared in this test for so long that it would be difficult for today's researchers to not have salt spray test data when they are presenting performance data on a new product to a potential end user.

### EXAMPLES

### Example 1

A ⅜″×2″ hex head machine screw electroplated with 0.00035″ of zinc was dipped in a 40% by weight solution of tetraethylorthosilicate and allowed to dry and cure for 24 hours. It was then placed in a salt spray cabinet for testing. After 108 hours, 45% of the surface was covered with white corrosion products and the balance with base metal corrosion (red rust).

### Example 2

A ⅜″×2″ hex head machine screw electroplated with 0.00035″ of zinc was dipped in Silbond H₆C, a partially hydrolyzed ethyl silicate and allowed to dry and cure for 24 hours. It was then placed in a salt spray cabinet for testing. After 108 hours, less than 2% of the surface showed traces of white corrosion products. Comparison of examples 1 and 2 shows that the alkyl silicate used in my invention must be partially prehydrolyzed.

### Examples 3-11

A solution was made from 700 ml of Silbond H₆C (available from Silbond Corporation, Weston, Mich.) and 300 ml of Quilon C (available from Zaclon Corporation, Cleveland, Ohio). To 95 ml of this solution was added 5 ml of an alkyl alkoxy silane as shown below. All alkyl alkoxy silanes are available from Aldrich Chemical, (Milwaukee, Wis.). ⅜″×2″ hex head machine screws electroplated with 0.00035″ of zinc were dipped into the resultant solution and the excess solution spun off. The parts were allowed to dry and cure for 24 hours, after which they were subjected to ASTM B-117 Salt Spray Testing. After 1008 hours, the parts were removed from the cabinet and graded for white rust and red rust (base metal corrosion).

| | After 1008 Hours of | |
|---|---|---|
| | ASTM B-117 Salt Spray Testing | |
| | | Red Rust |
| Silane Additive | White Rust | (Base Metal Corrosion) |
| (3) Tetraethylorthosilicate | 2% | 0% |
| (4) Methyltrimethoxysilane | 4% | 0% |
| (5) Trimethoxypropylsilane | 5% | 0% |
| (6) Isobutyltriethoxysilane | 6% | 0% |
| (7) Ethyltrimethoxysilane | 10% | 0% |
| (8) Ethyltriethoxysilane | 15% | 0% |
| (9) Octyltrimethoxysilane | 70% | 1-% |
| (10) Octadecyltrimethoxysilane | 30% | 2% |
| (11) Butyltriethoxysilane | 70% | 0% |

In general, the data seem to support the proposition that the lower molecular weight entities gave superior salt spray protection. Without wishing to be bound by any specific theory, I infer from the data that the more Si—O bonds, the better the performance in my invention.

### Example 12

25 grams of micronized polytetraflouroethylene (MP-1100, from duPont, Wilmington, Del.) were mixed in a blender at a high setting for 2 minutes with 25 ml of methyltrimethoxysilane and 450 ml of Silbond H₆C. This dispersion was applied to several ⅜″×2″ hex head machine screws electroplated with 0.00035″ of zinc. The parts were allowed to dry and cure for 24 hours, after which they were subjected to ASTM B-117 Salt Spray Testing. After 360 hours, the parts were removed from the cabinet and showed less than 5% white corrosion with no base metal corrosion (red rust).

### Example 13

A solution was made from 900 ml of denatured alcohol, 70 ml of Silbond H₆C (available from Silbond Corporation, Weston, Mich.). 25 ml of Quilon C (available from Zaclon Corporation, Cleveland) and 5 ml of methyltrimethoxysilane. ⅜″×2″ hex head machine screws mechanically plated with 0.00035″ of zinc were dipped into the resultant solution and the excess solution spun off. The parts were allowed to dry and cure for 24 hours, after which they were subjected to ASTM B-117 Salt Spray Testing. After 1008 hours, the parts were removed from the cabinet and showed 30% white corrosion with no base metal corrosion (red rust).

### Example 14

Best Mode Example

700 ml of Silbond H₆C were combined with 250 ml of Quilon C and 50 ml of methyltrimethoxysilane (available from Gelest, Tullytown, Pa.). ⅜″×2″ hex head machine screws electroplated with 0.00035″ of zinc were dipped into the resultant solution and the excess solution spun off. The parts were allowed to dry and cure for 24 hours, after which 5 parts were subjected to ASTM B-117 Salt Spray Testing by an independent AALA laboratory. After 1536 hours, during which none of the parts exhibited any white corrosion products, one of the five parts showed less than 10% red rust and the other 4 parts had no red rust.

While my invention has been described in conjunction with specific embodiments thereof, it is evident that many alternatives, modifications, and variations will be apparent to those skilled in the art in light of the foregoing description. Accordingly, it is intended to embrace all such alternatives, modifications and variations which fall within the spirit and broad scope of the appended claims.

1. A composition of matter comprising a partially hydrolyzed alkyl silicate and one or more waxy lubricants.

2. A composition as in claim 1 to which there is additionally added one or more alkyl alkoxy silanes

3. A composition as in claim 1 or claim 2 to which there is additionally added a tetraalkoxysilane.

4. A process comprising plating or coating a ferrous substrate with zinc, followed by immersion in a partially hydrolyzed alkyl silicate and a lubricant, followed by curing.

5. A process as in claim 1 to which there is additionally added to the treating solution one or more tetraalkoxy silanes.

6. A ferrous article coated with a metallic zinc coating, thence coated with a composition comprising a partially hydrolyzed alkyl silicate and one or more waxy lubricants

7. An article as in claim 6 to which there has been additionally added to the composition one or more alkylalkoxysilanes.

8. An article as in claim 6 or 7 to which there has been added to the coating composition one or more tetraalkoxysilanes.
